(19) United States
(12) Patent Application Publication
(10) Pub. No.: US 2023/0255239 A1
(43) Pub. Date: Aug. 17, 2023

(54) FEED ADDITIVE FOR IMPROVING INTESTINAL STRUCTURE OF LARIMICHTHYS CROCEA, FEED, AND USE

(71) Applicant: Ocean University of China, Qingdao (CN)

(72) Inventors: Qinghui AI, Qingdao (CN); Yuhang TANG, Qingdao (CN); Zhou ZHANG, Qingdao (CN); Zhen WANG, Qingdao (CN); Kangsen MAI, Qingdao (CN); Wei XU, Qingdao (CN)

(21) Appl. No.: 18/109,523

(22) Filed: Feb. 14, 2023

(30) Foreign Application Priority Data
Feb. 14, 2022 (CN) 202210132097.6

(51) Int. Cl. A23K 20/158; A23K 50/80

(52) U.S. Cl. CPC A23K 20/158; A23K 50/80

(57) ABSTRACT

The present disclosure relates to a feed additive for improving intestinal structure of Larimichthys crocea, a feed and use, and belongs to the field of aquatic animal nutritional feeds. The feed additive includes glyceryl monolaurate. The present disclosure further provides a feed containing the feed additive, and a mass percentage of the glyceryl monolaurate in the feed is 0.04%. The present disclosure further provides use of the feed additive in improving the intestinal structure of the L. crocea, and the use lasts for at least 70 days. The feed provided by the present disclosure can effectively improve intestinal morphological change, reduced intestinal villi, reduced intestinal perimeter ratio, and intestinal barrier damage caused by replacement of fish oil with soybean oil; and damage of intestinal antioxidant activity caused by replacement of fish oil with soybean oil is relieved.

### CROSS REFERENCE TO RELATED APPLICATION

This patent application claims the benefit and priority of Chinese Patent Application No. 202210132097.6, filed with the China National Intellectual Property Administration on Feb. 14, 2022, the disclosure of which is incorporated by reference herein in its entirety as part of the present application.

### TECHNICAL FIELD

The present disclosure belongs to the field of aquatic animal nutritional feeds, and particularly relates to a feed additive for improving intestinal structure of Larimichthys crocea, a feed and use.

### BACKGROUND

L. crocea belongs to the genus Larimichthys of the family Sciaenidae of the order Perciformes of the class Osteichthyes. L. crocea is mainly distributed in the Southeast China Sea area. Its meat is delicious and has certain medicinal value. It is a unique marine economic fish in China. According to the 2021 China Fishery Statistical Yearbook, the aquaculture production of L. crocea exceeded 250,000 tons, making it the largest marine economic fish in China.

With the rapid development of China's aquaculture industry in recent years, the demand for high-quality fat source for fish feed, fish oil, is expanding, and the supply-demand relationship of fish oil is gradually unbalanced. Seeking for alternatives to fish oil has become a hotspot in the marine fish aquaculture feed industry. Vegetable oils such as soybean oil and palm oil are widely used in the aquaculture of marine fish like L. crocea due to their low prices, wide sources and rich fatty acid content. However, it is found in actual production that the use of a high proportion of vegetable oil often leads to adverse effects including damage to the intestinal barrier of fish, reduction of intestinal villi, changes in intestinal structure and decrease of antioxidant capacity, which damages the health of fish and restricts the development of intensive mariculture. Therefore, it is urgent to find specific regulatory means to solve the problem of intestinal damage caused by replacement of high proportion of vegetable oil.

Glyceryl monolaurate is a monoglyceride derivative of lauric acid, which is widely used in aquaculture because of its excellent antibacterial and antiviral abilities and growth-promoting function. According to previous findings, adding a certain proportion of glyceryl monolaurate in the breeding feed of Lateolabrax maculatus can reduce abdominal fat deposition; using glyceryl monolaurate in the breeding of white shrimp can improve digestive enzyme activity and non-specific immune response and promote growth. However, it is not clear whether glyceryl monolaurate has an alleviating effect on intestinal structure repair and intestinal damage in aquatic animals.

### SUMMARY

The problem to be solved by the present disclosure is to provide a feed additive for improving intestinal structure of L. crocea, a feed and use. By adding a specific proportion of glyceryl monolaurate in the feed, intestinal barrier damage, reduced intestinal villi, and decreased antioxidant activity in L. crocea can be changed, which is expected to solve the technical barriers in the process of oil source substitution in the aquaculture industry.

The present disclosure is achieved by the following technical solutions:

A feed additive for improving intestinal structure of L. crocea is provided, and the feed additive includes glyceryl monolaurate.

The present disclosure further provides a feed containing the feed additive, and a mass percentage of the glyceryl monolaurate in the feed is 0.04%.

The present disclosure further provides use of the feed in improving the intestinal structure of the L. crocea, and the use lasts for at least 70 days.

Compared with the prior art, the present disclosure has the following beneficial effects:

1) The feed additive and the feed provided by the present disclosure can effectively improve intestinal morphological change, reduced intestinal villi, and intestinal barrier damage caused by replacement of fish oil with soybean oil.

2) The feed additive and the feed provided by the present disclosure can effectively relieve damage of intestinal antioxidant activity caused by replacement of fish oil with soybean oil (increased antioxidant enzyme activity and decreased malondialdehyde (MDA) content).

3) The glyceryl monolaurate provided by the present disclosure is a nutrient required by fish, has no toxic and side effects, and has no influence on food safety.

### BRIEF DESCRIPTION OF THE DRAWINGS

In order to illustrate the specific implementations of the present disclosure or the technical solutions in the prior art more clearly, the accompanying drawings that need to be used in the description of the specific implementations or the prior art will be briefly described below. Apparently, the accompanying drawings in the following description are some implementations of the present disclosure. For those of ordinary skill in the art, other drawings can also be obtained based on these drawings without creative efforts.

FIG. 1A-E illustrate hematoxylin-eosin (H&E) staining results of intestinal morphology of L. crocea across groups in Example 1 of the present disclosure; FIG. 1A represents the fish oil group, FIG. 1B represents the soybean oil group, FIG. 1C represents the soybean oil group added with 0.02% (w/w) glycerol monolaurate, FIG. 1D represents the soybean oil group added with 0.04% (w/w) glyceryl monolaurate, and FIG. 1E represents the soybean oil groups added with 0.08% (w/w) glyceryl monolaurate;

FIG. 2 illustrates intestinal villus height, muscle layer thickness and perimeter ratio of L. crocea across groups in Example 1 of the present disclosure;

FIG. 3 illustrates the expression of genes related to the intestinal physical barrier of L. crocea across groups in Example 1 of the present disclosure; and

FIG. 4 illustrates the intestinal antioxidant enzyme activity and MDA content of L. crocea across groups in Example 1 of the present disclosure.

### DETAILED DESCRIPTION OF THE EMBODIMENTS

The technical features of the present disclosure will be further explained below through the examples, but the protection scope of the present disclosure is not limited in any form by the examples.

### Example 1. Feed Manufacturing and Aquaculture Management Using this Method

1. Experimental Design and Experimental Feed Formula

Based on the soybean oil diet formula for L. crocea used in the laboratory in previous years, glycerol monolaurate with different mass percentages of 0.02%, 0.04%, and 0.08% (namely 200 mg/kg, 400 mg/kg, and 800 mg/kg) were supplemented, respectively. In addition, a conventional fish oil feed group was used as a negative control group. The feed formula is shown in Table 1.

TABLE 1
Formula and crude composition of experimental
feed (% dry composition)

| | Fish | Soybean | | | |
|---|---|---|---|---|---|
| | oil | oil | Addition | Addition | Addition |
| | group | group | group | group | group |
| Feed composition | (FO) | (SO) | (G0.02) | (G0.04) | (G0.08) |
| White fish meal¹ | 32 | 32 | 32 | 32 | 32 |
| Premium krill | 1 | 1 | 1 | 1 | 1 |
| meal¹ | | | | | |
| Dehulled soybean | 25 | 25 | 25 | 25 | 25 |
| meal¹ | | | | | |
| Bread flour¹ | 28.79 | 28.79 | 28.79 | 28.79 | 28.79 |
| Fish oil | 7 | 0 | 0 | 0 | 0 |
| Soybean oil | 0 | 7 | 7 | 7 | 7 |
| Soyabean lecithin | 2 | 2 | 2 | 2 | 2 |
| Compound | 0.2 | 0.2 | 0.2 | 0.2 | 0.2 |
| vitamin | | | | | |
| premix² | | | | | |
| Compound | 1 | 1 | 1 | 1 | 1 |
| mineral | | | | | |
| premix² | | | | | |
| Monocalcium | 2 | 2 | 2 | 2 | 2 |
| phosphate | | | | | |
| Ascorbyl | 0.05 | 0.05 | 0.05 | 0.05 | 0.05 |
| phosphate | | | | | |
| Mould inhibitor | 0.05 | 0.05 | 0.05 | 0.05 | 0.05 |
| Choline chloride | 0.2 | 0.2 | 0.2 | 0.2 | 0.2 |
| Ethoxyquin | 0.05 | 0.05 | 0.05 | 0.05 | 0.05 |
| Feed attractant⁴ | 0.5 | 0.5 | 0.5 | 0.5 | 0.5 |
| Glyceryl | 0 | 0 | 0.02 | 0.04 | 0.08 |
| monolaurate⁵ | | | | | |
| Microcrystalline | 0.16 | 0.16 | 0.14 | 0.12 | 0.08 |
| cellulose (MCC) | | | | | |
| Nutrient % | | | | | |
| Crude protein | 42.16 | 42.96 | 42.53 | 42.98 | 42.17 |
| (CP) | | | | | |
| Ether extract | 12.59 | 12.52 | 12.30 | 12.64 | 12.60 |
| (EE) | | | | | |

¹White fish meal (74% CP and 12.6% EE); premium krill meal (53.18% CP and 13% EE); dehulled soybean meal (46.68% CP and 0.33% EE); and strong flour (19.66% CP and 0.98% EE).
²Compound vitamin premix (mg/kg diet) (retinyl acetate, 3; vitamin D, 35; alpha-tocopherol, 240; vitamin K, 240; vitamin B1, 25; vitamin B2, 45; pyridoxine hydrochloride, 20; vitamin B12, 10; pantothenic acid, 60; folic acid, 20; nicotinic acid, 200; biotin, 60; inositol, 800; and MCC, 13473)
³Compound mineral premix (mg/kg diet) (magnesium sulfate, 1200; copper sulfate, 10; ferrous sulfate, 80; zinc sulfate, 50; manganese sulfate, 45; cobalt chloride, 50; sodium selenite, 20; calcium iodate, 60; and zeolite powder, 13485;)
⁴Glycine and betaine.
⁵Glycerol monolaurate: 92% pure.

2. Experimental Fish and Aquaculture Management

In this experiment, a total of 540 experimental L. crocea juveniles with an initial body weight of 13 g were selected, and the fry were purchased from Ningde Fufa Fisheries Co., Ltd., Fujian Province. The fry were randomly divided into three groups with three replicates of 60 fish fry, and the aquaculture period was 10 weeks. After the formal experiment started, the fry were fed heavily at 5:00 a.m. and 17:00 p.m. every day, the surface debris was cleaned up, and dead fish were removed at irregular intervals. During the experiment, the water temperature was maintained at 19.3-22.8° C., the salinity was at 25.6-29.9‰, and the dissolved oxygen level was 6.1-7.0 mg/L.

3. Collection and Analysis of Experimental Samples

At the end of the aquaculture experiment, sampling was performed 24 h after fasting. After the experimental fish was anesthetized, the intestines were quickly dissected out and stored in liquid nitrogen for subsequent analysis of intestinal barrier-related gene expression and antioxidant enzyme activity. Another three juveniles were taken to obtain the hindgut, which was rinsed with phosphate-buffered saline (PBS) and then fixed in paraformaldehyde for paraffin section preparation. Intestinal antioxidant enzyme activity and MDA content were detected by commercial kits.

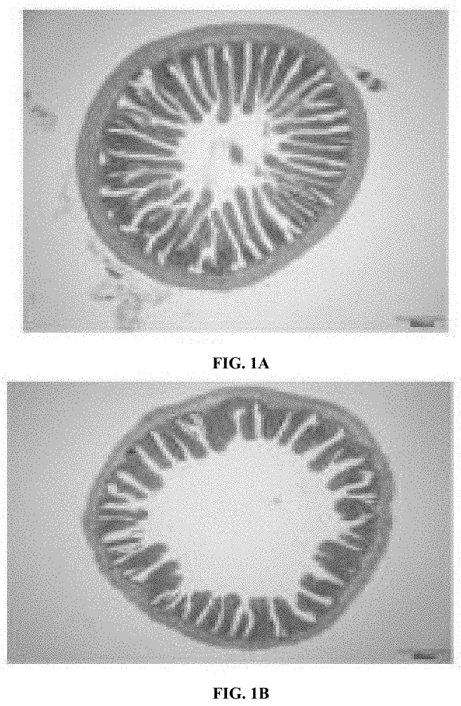

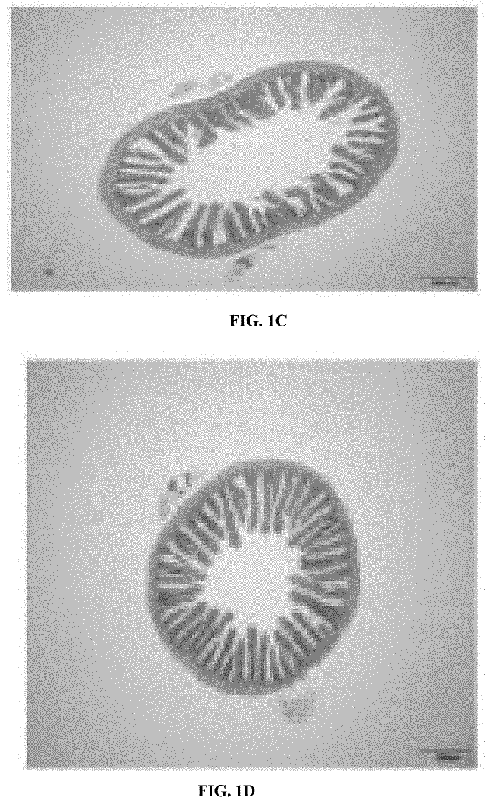

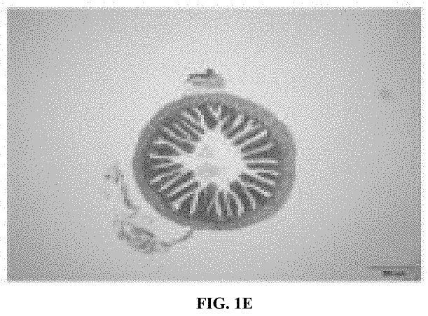

As shown in FIG. 1A-E, compared with the fish oil group, the soybean oil group showed obvious damage to the intestinal structure, while the damage to the intestinal structure was alleviated and the number of intestinal villi increased in the addition group that used this method.

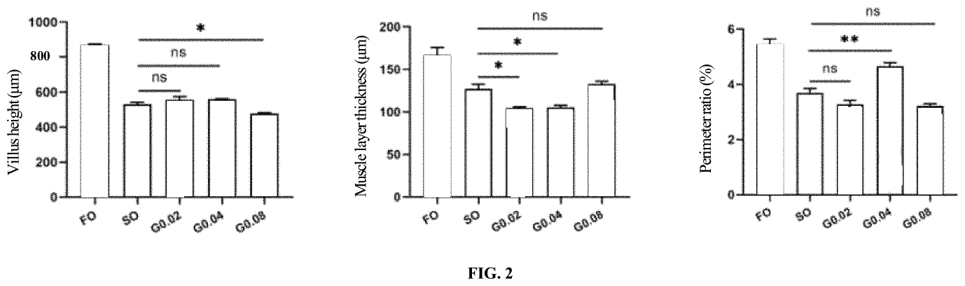

As shown in FIG. 2, the intestinal villus height and the intestinal perimeter ratio were significantly reduced in the soybean oil group, while the intestinal villus height was relatively improved in the addition group that used this method; the intestinal perimeter ratio in the 0.04% addition group was significantly higher than that in the soybean oil group.

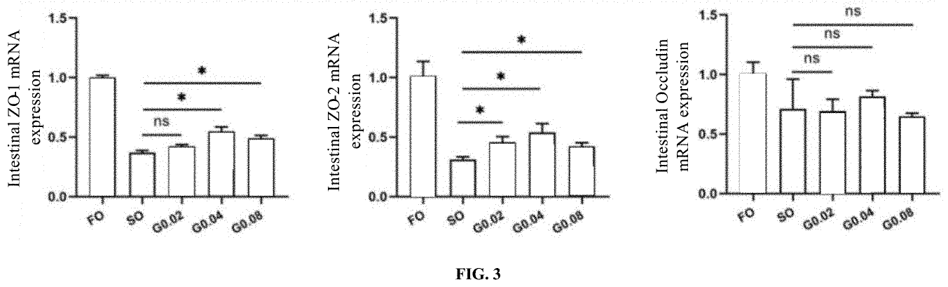

As shown in FIG. 3, the expression of intestinal barrier-related genes was significantly downregulated in the soybean oil group, while the expression of intestinal barrier-related genes was relatively unregulated in the addition group that used this method; the expression of intestinal barrier-related genes in the 0.04% addition group was significantly higher than that of the soybean oil group.

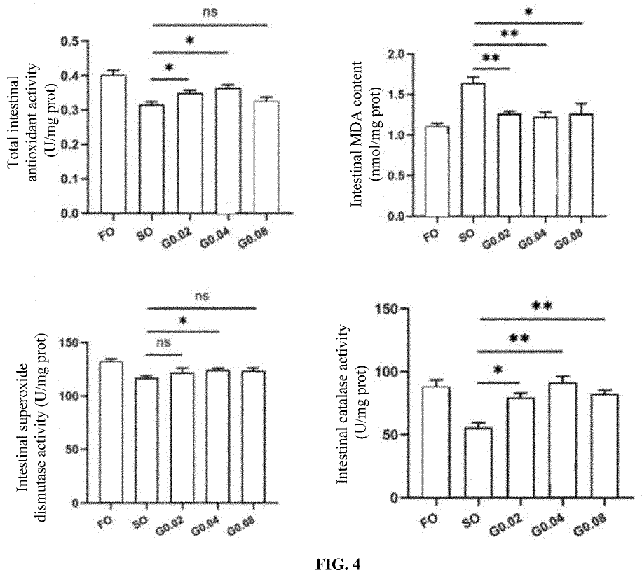

As shown in FIG. 4, the intestinal antioxidant enzyme activity decreased significantly and the MDA content decreased in the soybean oil group, while the antioxidant activity was significantly improved in the addition group that used this method. Herein, the antioxidant activity of the 0.04% addition group was significantly higher than that of the soybean oil group.

What is claimed is:

1. A feed additive for improving intestinal structure of Larimichthys crocea, wherein the feed additive comprises glyceryl monolaurate.

2. A feed comprising the feed additive according to claim 1, wherein a mass percentage of the glyceryl monolaurate in the feed is 0.04%.

3. A treatment method for improving intestinal structure of Larimichthys crocea by using the feed according to claim 2, wherein the treatment lasts for at least 70 days.
